(19) United States
(12) Patent Application Publication
(10) Pub. No.: US 2009/0150845 A1
(43) Pub. Date: Jun. 11, 2009

(54) METHOD FOR DRIVING CURRENT OF CELL LIBRARY

(76) Inventor: Woo-Hyun Park, Anyang-si (KR)

Correspondence Address: SHERR & VAUGHN, PLLC, 620 HERNDON PARKWAY, SUITE 200, HERNDON, VA, 20170, US

(21) Appl. No.: 12/326,897

(22) Filed: Dec. 3, 2008

(30) Foreign Application Priority Data
Dec. 6, 2007 (KR) 10-2007-0126223

(51) Int. Cl. G06F 17/50; H02J 1/00

(52) U.S. Cl. 716/6; 323/318

(57) ABSTRACT

Embodiments relate to a cell library for an application specific integrated circuit (ASIC). Embodiments relate to a method for defining current drive capacity of a cell library, which may define an amount of various kinds of drive current in a single pin and driving current in the cell library. According to embodiments, a method may include defining a current drive capacity for the cell library, receiving a timing arc selected by an external control switch, checking a current drive level defined in the input timing arc, searching for an index table defined in the checked current drive level, and driving a current written on the searched index table.

The present application claims priority under 35 U.S.C. 119 to Korean Patent Application No. 10-2007-0126223 (filed on Dec. 6, 2007), which is hereby incorporated by reference in its entirety.

### BACKGROUND

A semiconductor integrated circuit may be divided into a standard integrated circuit such as a memory and/or an application specific integrated circuit (ASIC). An ASIC may refer to a user demand integrated circuit which may be manufactured for specific usage.

An ASIC design technique may design and verify frequently used cells. It may analyze and extract characteristics of cells. It may store materials in a cell library and may then use them when designing a chip. An ASIC design technique may be designed to shorten a design period and enhance a reliability of products. To perform an ASIC design and its simulation, a cell library may be assembled and an application to interpret a signal delay and electrical characteristics may be performed using the cell library.

If two or more current supply sources are used to operate an electric circuit, for example, when a library user drives an amount of selective current, various kinds of current may be driven from a single output terminal. For example, in an I/O cell with a switch capable of controlling an amount of current discharged to an outside of a chip, different amounts of current may be driven in a single pin by selecting a switch.

From 0.13 μm or less, a technique to select an amount of current in an I/O library cell using programs may be applied as a main design technique. An I/O cell to which such a design technique may be applied may be used as main factor according to an application request. However, when defining a current drive capacity of a cell library in the related art, only a single amount of current may be defined in a single pin. Various kinds of and/or amounts of current constituted using programs may not be defined in a single pin as shown below. The following may be a defining pad example provided by a library compiler.

library (example1) {

date : “August 12, 2005” ;
revision : 2005.05;
...
time_unit : “1ns”;
voltage_unit : “1V”;
current_unit : “1uA”;
pulling_resistance_unit : “1kohm”;
capacitive_load_unit ( 0.1,ff );
...
output_voltage (GENERAL) {

vol : 0.4;
voh : 2.4;
vomin : −0.3;
vomax : VDD + 0.3;

}
/***** OUTPUT PAD *****/
cell (OUTBUF) {

area : 0.000000;
pad_cell : true;
pin(D ) {

direction : input;
capacitance : 1.800000;

}
pin(PAD ) {

direction : output;
is_pad : true;
drive current : 2.0;
output_voltage : GENERAL;
function : “D”;
timing ( ) {
}

}

}

Therefore, a type of cell library capable of selectively driving an amount of current may be a problem. Because of such a problem, an application for exact power interpretation and delay effects may not be performed when using the cell library.

According to the related art, although a drive capacity of an I/O cell may be selectively applied with 2 mA, 4 mA, 8 ma and 12 mA, it may not describe a large amount of current in a single pin. This may cause a problem that an application requiring an exact current drive capacity if such a cell library is used may not be performed.

### SUMMARY

Embodiments relate to a cell library for an application specific integrated circuit (ASIC). Embodiments relate to a method for defining current drive capacity of a cell library, which may define an amount of various kinds of drive current, in a single pin and driving current in a cell library.

Embodiments relate to a method for defining current drive capacity of a cell library, which may selectively define an amount of current, and driving current in a cell library.

According to embodiments, a method for driving current of a cell library may include at least one of the following. Defining a current drive capacity for the cell library. Receiving a timing arc selected by an external control switch. Checking a current drive level defined in the input timing arc. Searching for an index table defined in the checked current drive level. Driving current written on the searched index table.

According to embodiments, defining the current drive capacity for the cell library may include writing a current drive capacity for each pin of the cell library. According to embodiments, defining the current drive capacity for the cell library may include at least one of the following. Defining a current level field applied to any single pin. Defining a plurality of index tables referring to the current level field applied to the single pin. Recording any one of current levels defined in the plurality of index tables according to various timing arcs.

According to embodiments, the cell library may be an Input/Output (I/O) cell library for designing an Application Specific Integrated Circuit (ASIC). According to embodiments, the timing arc may be a timing selected by a switch input signal received from a plurality of external control switches.

### DRAWINGS

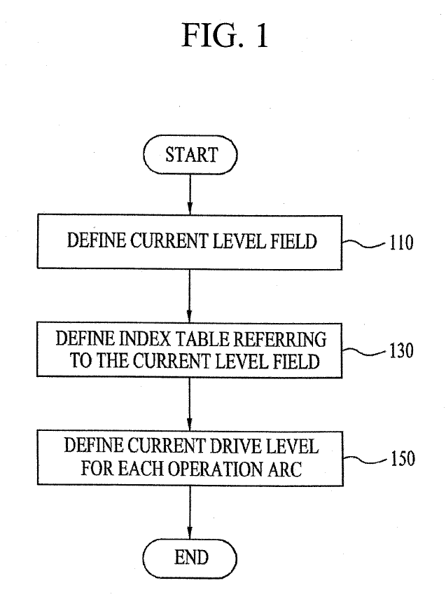

Example FIG. 1 is a flowchart illustrating a method for writing a current drive capacity of a cell library, according to embodiments.

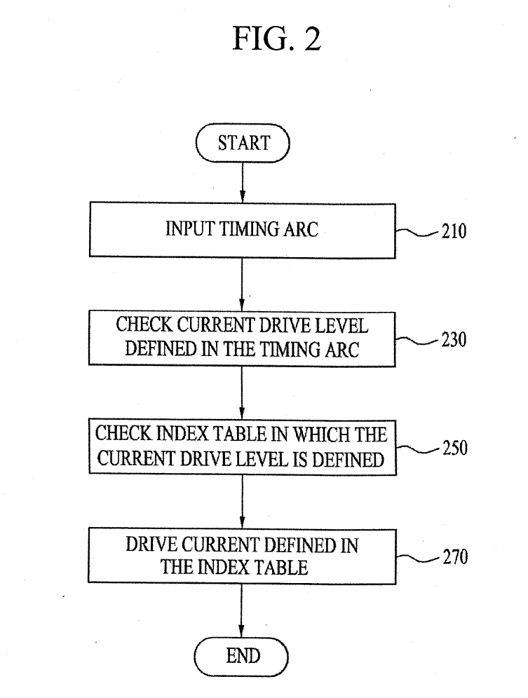

Example FIG. 2 is a flowchart illustrating a method for driving current of a cell library according to embodiments.

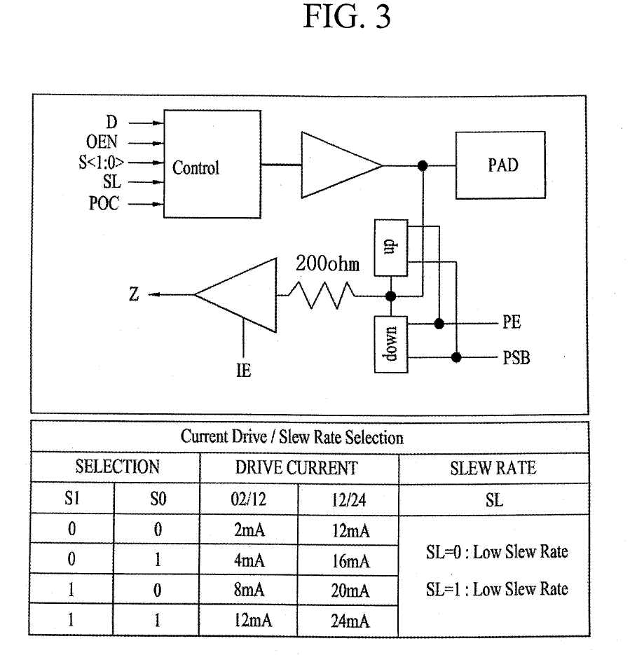

Example FIG. 3 is a drawing illustrating an I/O cell that may be capable of selectively driving an amount of current and a truth table, according to embodiments.

### DESCRIPTION

A method for defining a specific power voltage value for each pin of a cell library and a constitution of the cell library may be disclosed in “Library Compiler and Liberty Reference Manual (Version 2007)” edited by Synopsys Inc. and an explanation thereof will thus be omitted. A method for writing a current drive capacity for each pin of a cell library according to embodiments and driving a current thereof in the library cell will be described.

Example FIG. 1 is a flowchart describing a method for writing a current drive capacity of a cell library, according to embodiments. Referring to example FIG. 1, a method for writing a current drive capacity of a cell library according to embodiments may include defining a current level field applied to any certain pin (S110). An index table referring to the current level field may be defined (S130). Current drive levels for each operation arc as any one of current levels defined in the index table may be defined (S150). Each step will be described.

First, a current level field applied to a pin may be defined (S110). This may be to set the current level field to be recorded with a large amount of current to be driven in the pin within a library. The following is an example, according to embodiments.

library (library name) {

...
drive_current ( ) {
...

}
}

According to embodiments, a current level field to be recorded with a large amount of current to be driven in a pin, that is, drive_current ( ), may be set in the library.

According to embodiments, an index table referring to a current level field may be defined (S130). This may be to write a large amount of actual current to be driven in the pin on the index table referring to the current level field. The following is an example, according to embodiments.

library (library name) {

...
drive_current ( ) {
sdf_cond(_drive_2, 2);
sdf_cond(_drive_4, 4);
sdf_cond(_drive_8, 8);
...
}

}

According to embodiments, index tables sdf_cond having as many as a number of currents to be driven in drive_current ( ), a current level field, may be set. According to embodiments, an amount of current may be defined in the index tables. According to embodiments, three index tables may be defined as drive_{—}2 for 2 mA drive current, drive_{—}4 for 4 mA drive current, and drive_{—}8 for 8 mA drive current, respectively.

According to embodiments, current drive levels for each operation arc written for a specific cell library may be defined by any one of current levels defined in an index table (S150). According to embodiments, an operation arc may be a timing selected by an external control switch. According to embodiments, it will be described as a timing arc. This may designate an amount of current set in the index table selectively according to the designated timing arc. The following is an example, according to embodiments.

```
cell(cell name) {
...
pin (pin name) {
...
timing( ) {
  related_pin : “input pin”
  sdf_cond : “S0===1′b0 && S1====1′b0 && SL====1′b0”;
  drive_current_level : _drive_2;
timing( ) {
  related_pin : “input pin”
  sdf_cond : “S0===1′b1 && S1====1′b0 && SL====1′b0”;
  drive_current_level : _drive_4;
...
```

According to embodiments, an amount of current driven according to a plurality of timing arcs defined for any one cell library may be defined as any one of the amounts of current defined in the index table. Therefore, if a timing arc is selected by an external control switch or the like, an amount of current designated for a timing arc may be driven. According to embodiments, when one external control switch S0 is selected as 0 and another external control switch S1 is set as 0, 2 mA may be driven. According to embodiments, when one external control switch S0 is selected as 1 and another external control switch S1 is set as 0, 4 mA may be driven.

Example FIG. 2 is a flowchart describing a method for driving current of a cell library, according to embodiments. Referring to example FIG. 2, first a cell library, which may be defined according to embodiments, may receive a switch selection signal from an external control switch. The external control switch may be connected to an outside of the cell library. According to embodiments, the cell library may receive a selected timing arc (S210).

The cell library that may receive a timing arc may check a current drive level defined in the input timing arc (S230). According to embodiments, the cell library may search for an index table in which the checked current drive level may be defined (S250). According to embodiments, the cell library may drive the current written on the searched index table (S270).

According to embodiments, the cell library in which a large amount of drive current may be defined may drive any one of a large amount of current according to a switch selection signal input, which may be provided from outside.

Example FIG. 3 is a drawing illustrating an I/O cell that may be capable of selectively driving an amount of current and a truth table, according to embodiments. According to embodiments, an I/O cell of example FIG. 3 may drive different amounts of current to pad PAD of a chip, when being operated in an output mode by external control switches S1 and S0 connected to a control.

According to embodiments, when S1 is 0 and S0 is 0, drive current may be 2 mA. According to embodiments, when S1 is 0 and S0 is 1, drive current may be 4 mA. According to embodiments, when S1 is 1 and S0 is 0, drive current may be 8 mA. According to embodiments, when S1 is 1 and S0 is 1, drive current may be 12 mA.

A method of embodiments described above may be implemented as a program that may be stored in a recording medium being that may be readable by a computer (for example, CD ROM, RAM, ROM, floppy disk, hard disk, magneto-optical disk, or the like). This process may be known by those skilled in the art.

According to embodiments, a cell library driving various amounts of current with the control of external switches may be defined. This may make it possible to perform an application requiring various amounts of current drive and perform a substantially exact electrical interpretation. According to embodiments, a cell library may be used, which may make it possible to perform an application requiring an exact current drive capacity.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method comprising:
defining a current drive capacity for a cell library;
receiving a timing arc selected by an external control switch;
checking a current drive level defined in the timing arc;
searching for an index table defined in the checked current drive level; and
driving a current defined on the index table.

2. The method of claim 1, wherein defining the current drive capacity for the cell library comprises writing a current drive capacity for each pin of the cell library.

3. The method of claim 1, wherein defining the current drive capacity for the cell library comprises:
defining a current level field applied to a single pin;
defining a plurality of index tables referring to the current level field applied to the single pin; and
recording at least one current level defined in the plurality of index tables according to corresponding timing arcs.

4. The method of claim 3, wherein defining the current level field applied to the single pin comprises setting the current level field with an amount of current to be driven in the single pin within the cell library.

5. The method of claim 3, wherein defining the plurality of index tables comprises defining as many index tables as a number of currents to be driven in the defined current level field, and defining an amount of current in the plurality of index tables.

6. The method of claim 5, wherein defining the amount of current in the plurality of index tables comprises recording an amount of current to be driven in the single pin in one of the plurality of index table referring to the defined current level field.

7. The method of claim 1, wherein the cell library comprises an Input/Output (I/O) cell library for designing an Application Specific Integrated Circuit (ASIC).

8. The method of claim 1, wherein the timing arc comprises a timing selected by a switch input signal received from a plurality of external control switches.

9. A method comprising:
defining a current level field applied to a single pin;
defining a plurality of index tables referring to the current level field applied to the single pin; and
recording current levels defined in the plurality of index tables according to corresponding timing arcs.

10. The method of claim 9, wherein defining the current level field applied to the single pin comprises setting the current level field with an amount of current to be driven in the single pin within a cell library.

11. The method of claim 9, wherein defining the plurality of index tables comprises defining as many index tables as a number of currents to be driven in the defined current level field, and defining an amount of current in the plurality of index tables.

12. The method of claim 11, wherein defining the amount of current in the plurality of index tables comprises recording an amount of current to be driven in the single pin in one of the plurality of index tables referring to the defined current level field.

13. The method of claim 9, further comprising writing a current drive capacity for each pin of a cell library.

14. A device comprising:
an external switch; and
a current source configured to receive a signal from the external switch and generate a plurality of currents, wherein an amount of current generated by the current source is determined by:
defining a current drive capacity for a cell library;
receiving a timing arc selected by the external switch;
checking a current drive level defined in the timing arc;
searching for an index table defined in the checked current drive level; and
driving the amount of current written in the index table.

15. The device of claim 14, wherein the amount of current is one of 2 mA, 4 mA, 8 mA, and 12 mA according to the signal from the external switch.

16. The device of claim 14, wherein defining the current drive capacity for the cell library comprises:
defining a current level field applied to a single pin;
defining a plurality of index tables referring to the current level field applied to the single pin; and
recording at least one current level defined in the plurality of index tables according to corresponding timing arcs.

17. The method of claim 16, wherein defining the current level field applied to the single pin comprises setting the current level field written with the amount of current to be driven in the single pin within the cell library.

18. The method of claim 16, wherein defining the plurality of index tables comprises defining as many index tables as a number of currents to be driven in the defined current level field, and defining the amount of current in the plurality of index tables.

19. The method of claim 18, wherein defining the amount of current in the plurality of index tables comprises recording the amount of current to be driven in the single pin in the index table referring to the defined current level field.

20. The method of claim 14, wherein the cell library comprises an Input/Output (I/O) cell library for designing an Application Specific Integrated Circuit (ASIC).
